(19) United States
(12) Patent Application Publication
(10) Pub. No.: US 2023/0257306 A1
(43) Pub. Date: Aug. 17, 2023

(54) MIX FORMULATION FOR 3D PRINTING OF STRUCTURES

(71) Applicant: ICON Technology, Inc., Austin, TX (US)

(72) Inventor: Kunal Kupwade-Patil, Austin, TX (US)

(73) Assignee: ICON Technology, Inc., Austin, TX (US)

(21) Appl. No.: 18/081,567

(22) Filed: Dec. 14, 2022

Related U.S. Application Data
(60) Provisional application No. 63/289,547, filed on Dec. 14, 2021.

(51) Int. Cl. C04B 28/26; C04B 28/00; C04B 28/02; C04B 28/06; C04B 28/08; C04B 14/06; C04B 22/06; C04B 40/00; B33Y 40/20; B33Y 70/00

(52) U.S. Cl. CPC C04B 28/26; C04B 28/001; C04B 28/021; C04B 28/06; C04B 28/08; C04B 14/06; C04B 22/062; C04B 40/0017; C04B 40/0082; B33Y 40/20; B33Y 70/00; C04B 2111/00129

(57) ABSTRACT

Mix formulation for 3D printing of structures is described, including a composition of an aluminosilicate source and an activator. Also described is a method that includes combining a composition having an aluminosilicate source and an activator with aggregate to yield a mixture, extruding a first quantity of the mixture through a nozzle to form a first layer of the mixture, extruding a second quantity of the mixture through the nozzle to form a second layer of the mixture substantially on the first layer, and curing the first layer and the second layer to yield a structure printed using a 3D printer.

### CROSS-REFERENCE TO RELATED APPLICATIONS

This nonprovisional patent application claims the benefit of copending U.S. Provisional Patent Application No. 63/289,547, filed Dec. 14, 2021 and titled, “MIX FORMULATION FOR 3D PRINTING OF STRUCTURES,” all of which is herein incorporated by reference in its entirety for all purposes.

### FIELD

The present invention relates generally to materials science, structural construction technology, additive manufacturing techniques, additive construction techniques, compositions for use in construction of structures, and three dimensional (3D) printing. More specifically, mix formulation for 3D printing of Structures is described.

### BACKGROUND

Conventionally, structures such as dwellings, buildings, and sheds are manufactured using a multitude of different materials and construction methods. Among the materials commonly used in the construction of structures is concrete. In conventional examples, concrete may be utilized in the foundation of a structure and possibly in the construction of exterior walls.

Conventionally, Portland cement (OPC) is one of the primary forms of cement used for construction of concrete structures. Portland cement is a fine powder, produced by heating limestone and clay minerals in a kiln to form clinker (primarily calcium silicates (CaO)₂₋₃SiO₂, alite Ca₃Si and belite Ca₂Si), tricalcium aluminate Ca₃Al₂O₄, and tetracalcium aluminoferrite Ca₄AlnFe₂-nO₇), grinding the clinker, and adding 2 to 3 percent of gypsum. However, concrete, Portland cement, mortar, and other conventional compounds are not used as a sole material for the construction of structures due to limitations that can be overcome by using additives, which can create significant and substantial costs.

Thus, what is needed is a structural construction compound without the limitations of conventional techniques.

### SUMMARY

In some examples, a composition includes an aluminosilicate source and a chemical activator. An exemplary aluminosilicate source may be one or more of rice husk ash, volcanic ash, crushed rocks which are high in alumina content, clays, silica/alumina soils, and shale powder, among others. An exemplary aluminosilicate source may also be one or more of ground granulated blast furnace slag, metakaolin, coal fly ash, bottom ash, municipal solid waste incinerator ash, cement kiln dust, limestone dust, or others.

In some examples, an aluminosilicate source and composition may range from about 10 mass % (i.e., mass %=mass percentage) to about 80 mass % SiO₂ and about 2 mass % to about 40 mass % Al₂O₃. An exemplary composition may include an aggregate such as sand, gravel, crushed stone, or others, without limitation or example. An exemplary aggregate may have a particle size ranging between about 1 mm and about 2 mm. In some examples, an activator element or material may also be used. An exemplary activator may include a base activator such as sodium hydroxide, sodium silicate, or the like, without limitation or restriction. As an example, an exemplary mass ratio of a base activator to an amount of sodium silicate may be between about 1:1 and about 2:1. An exemplary base activator such as sodium silicate may be added, mixed, or otherwise used in solution. In some examples, a concentration of a base activator may be in a range of about 4M (M=moles) to about 14M. An exemplary base activator and an additive such as sodium silicate may also be added to exemplary compounds and compositions, as described herein, may be solids. In some examples, compounds and compositions (hereafter referred to as “compounds” or “compositions”) may include an additive beyond those described herein.

In another example, an exemplary method of forming a structure by additive manufacturing (i.e., additive construction or 3D printing) includes combining a composition above with one or more aggregates to yield a mixture, extruding a first quantity of the mixture through one or more nozzles to form a first layer of the mixture on a substrate, extruding a second quantity of the mixture through one or more nozzles to form a second layer of the mixture on the first layer, and curing the first layer and the second layer to yield the structure.

In some examples, exemplary compositions may include water, which may be combined with a mixture before extruding a first quantity of the combined mixture.

In other examples, a method of forming a structure by additive manufacturing may include combining the above-described materials with water and aggregate to yield a mixture, extruding a first quantity of the mixture through one or more nozzles to form a first layer of the mixture on a substrate (e.g., a foundation), extruding a second quantity of the mixture through one or more nozzles to form a second layer of the mixture on a first layer, and curing the first layer and the second layer to yield the structure.

In some examples, curing a first layer and the second layer may include ultraviolet curing or thermal activation. Curing a first layer and second layer, in some examples, may include bonding the second layer to the first layer and the first layer to the substrate. In some examples, a structure may be an exterior or interior wall, roof, or any other type of structural element or feature, and the substrate may be a foundation. In some examples, one or more nozzles used to extrude mixtures such as those described herein may be heated. An additional amount of an activator material or compound (herein used interchangeably with “activator” may be combined with a mixture at one or more nozzles.

As described herein, exemplary material suitable for construction of structures may be formed from an aluminosilicate source and an alkali activator. Structures may be constructed with or without using Portland cement binders, the latter of which may permit reduction of a carbon footprint in individual construction projections and permit overall carbon emissions to be reduced. In some examples, this may include using structurally strengthened materials such as the above-described mixtures, compounds, and compositions, which can be extruded using additive manufacturing processes to create structures while preserving natural limited resources such as wood, the logging of which can have a deleterious effect by devastating forests and other organic oxygen-producing mechanisms critical to the survival of life on earth. Further, exemplary material may be suitable for construction using a 3D printing process, which may result in increased speed, greatly reduced cost, and greater flexibility for architectural and structural design by creating structural aspects, facets, facades, and other structural, cosmetic, or non-structural elements, without limitation or restriction.

Other elements of the inventive subject matter described herein are further apparent from the following detailed description, figures, and claims.

### BRIEF DESCRIPTION OF THE DRAWINGS

Various embodiments of the invention are disclosed in the following detailed description and the accompanying drawings:

FIG. 1A is an exemplary mix formulation for 3D printing of structures;

FIG. 1B is an alternative exemplary mix formulation for 3D printing of structures;

FIG. 2 is a perspective view of an exemplary construction system;

FIG. 3 is another perspective view of an exemplary construction system;

FIG. 4 is an exemplary process for an exemplary mix formulation for 3D printing of structures; and

FIG. 5 is an alternative exemplary process for an exemplary mix formulation for 3D printing of structures.

Like reference numbers and designations in the various drawings indicate like elements, features, functions, or structures.

### DETAILED DESCRIPTION

Various embodiments or examples may be implemented in numerous ways, including as a system, a process, an apparatus, or a composition of matter (i.e., “composition”). In general, operations of disclosed processes may be performed in an arbitrary order, unless otherwise provided in the claims. Compositions of matter may be referred to as “compositions,” which may be created, generated, formed, or otherwise made by combining, in any order unless specified otherwise, different elements, components, material (natural or synthetic), or the like.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description. Like numbered elements and reference numbers may refer to similar elements despite being described in connection with different drawings. The described techniques may be varied and are not limited to the examples or descriptions provided.

In some examples, compositions of matter such as cement are used for the building, development, or construction (hereafter “construction”) of infrastructure (e.g., buildings, dwellings, homes, houses, commercial office buildings, shelters (on and off-world), roads, bridges, dams, and the like). However, using the techniques and compositions described herein, carbon dioxide emissions can be reduced by limiting the production and use of materials such as Portland cement, which is considered the third-largest producer of CO₂ emissions globally, with an estimated 3.5 billion tons of cement made annually accounting, which, by some measures, can account for almost 8-10% of total global carbon dioxide (i.e., CO₂) emissions. Thus, non-Portland cementitious binders may be used to reduce carbon dioxide emissions and humankind's overall carbon footprint on the planet (i.e., “earth,” “planet earth,” and “planet” may be used interchangeably hereafter).

In some examples, a composition that includes an aluminosilicate source and uses a process of alkali activation to yield a geopolymer might address these issues. As used herein, “geopolymer” generally refers to an aluminosilicate forming a long-range, covalently bonded, non-crystalline (amorphous) network. Such a composition can be used in a 3D printing apparatus and method to produce a 3D printed structure. Moreover, such a composition can produce a durable and sustainable cementitious binder that can last for years.

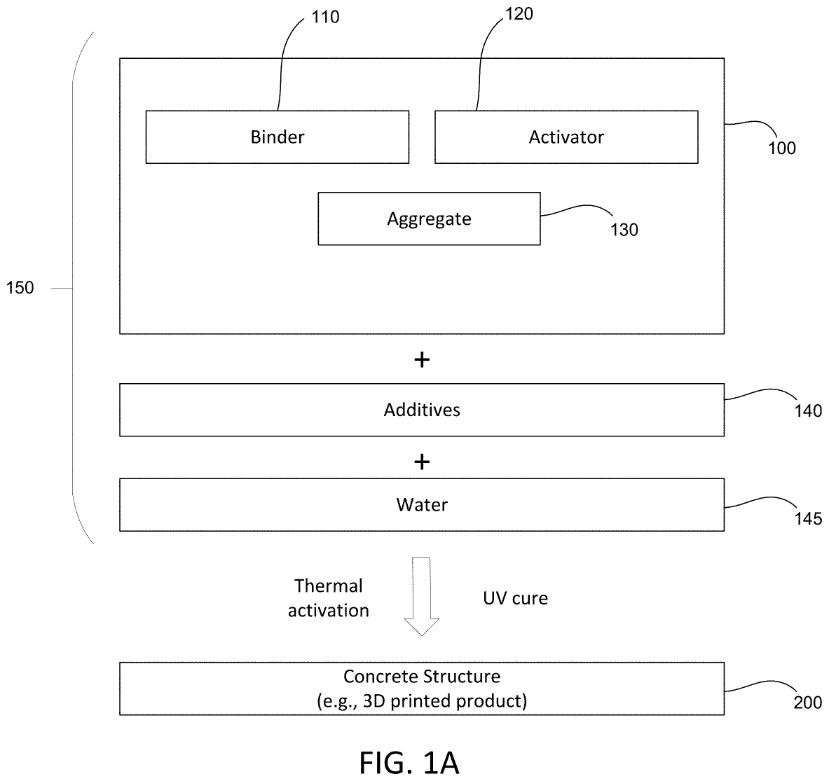

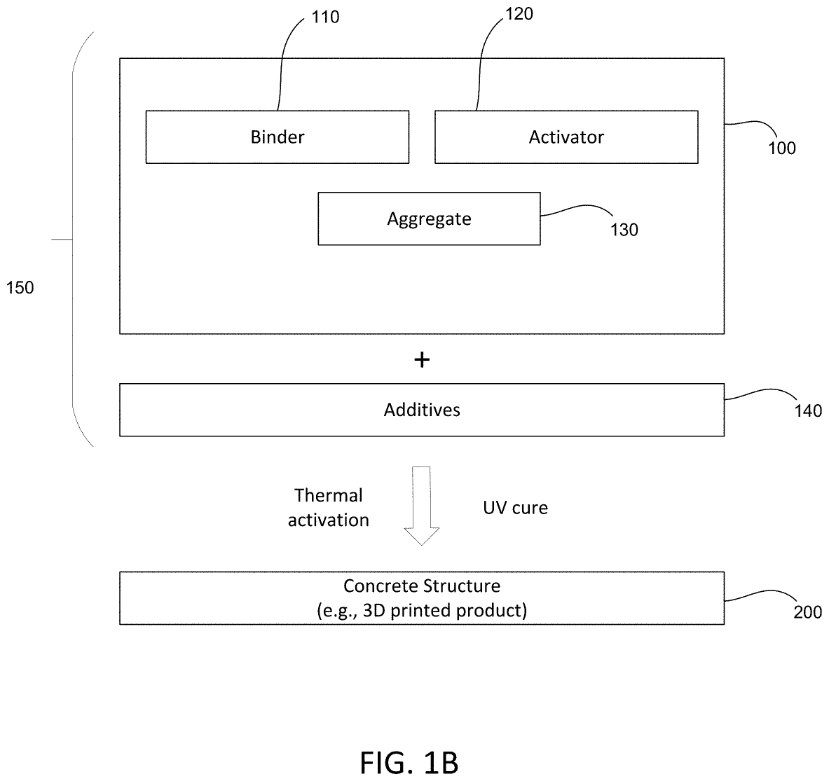

FIG. 1A is an exemplary mix formulation for 3D printing of structures. Here, the composition 100 includes a binder 110 and a chemical activator 120. The binder 110 includes an aluminosilicate source which may be alkali activated using the chemical activator 120. The aluminosilicate source can include natural or organic materials, waste materials, recycled materials, reclaimed materials, synthetic materials, manufactured materials, regolith, or the like, individually or as a combination thereof, without limitation or restriction. Examples of natural materials include rice husk ash, volcanic ash, crushed rocks which are high in alumina content, clays, silica/alumina soils, and shale powder, among others, without limitation or restriction. Examples of recycled or industrial waste by-products include ground granulated blast furnace slag, metakaolin, coal fly ash, bottom ash, municipal solid waste incinerator ash, cement kiln dust, and limestone dust, among others. The aluminosilicate source can include materials having about 10 mass % to about 80 mass % SiO₂ and about 2 mass % to about 40 mass % Al₂O₃.

The composition 100 also includes aggregate 130, which may include inert granular materials such as sand, gravel, crushed stone, decomposed granite, or others, without limitation or restriction. In some examples, aggregate particle size can range from approximately 1 mm to about 2 mm. Further, in some examples, a mass ratio of aggregate to aluminosilicate source is typically in a range that is substantially between 3:1 and 4:1 (e.g., about 3.5:1). In some examples, aluminosilicate source can vary from approximately 22% to 65% by mass, while the aggregate can vary between approximately 55%-77% by mass.

As described herein, in some examples, aggregate 130 can be provided from natural or waste materials that provide an aluminosilicate source and/or be separately added to composition 100. In some examples, aggregate or similar particulates are removed from an aluminosilicate source so that a base mixture (e.g., binder 110 and chemical activator (“activator”) 120) can be stored in a form substantially without aggregate. In some examples, a base mixture may be stored as a powder to be combined with aggregate 130 and the base mixture (i.e., binder 110 and activator 120) at the time of dispensing. As used herein, “dispensing” may refer to extrusion or the production of a combined mixture (e.g., binder 110, activator 120, and aggregate 130) when, for example, extruded or “printed” using one or more nozzles, as described in greater detail below.

In some examples, activator 120 may be a two-part activator (i.e., include two components, compositions, elements, substances, or the like). As an example, a two-part activator may include a base (e.g., sodium hydroxide) and a sodium silicate (e.g., Na₂ₓSi_{y}O_{2y+x} or (Na₂O)ₓ·(SiO₂)_{y}, sodium metasilicate (Na₂SiO₃), sodium orthosilicate (Na₂SiO₄), sodium pyro silicate (Na₆Si₂O₇), or others, without limit or restriction, including combinations thereof). In other examples, one or both parts of a two-part activator 120 may be in the form of a liquid (e.g., the base (e.g., binder 110 and chemical activator (“activator”) 120) is in solution, sodium silicate is in solution, or a base is in solution and sodium silicate is in solution).

In some examples, an amount of base (e.g., binder 110 and chemical activator (“activator”) 120) can be selected such that a concentration of a base (e.g., binder 110 and chemical activator (“activator”) 120) in the activator is in a range of about 4M to about 14M. In other examples, both parts of a two-part activator may be in the form of a solid. A mass ratio of the base to the sodium silicate is typically in a range between approximately 1:1 to approximately 2:1. Other types of activators include potassium and bromide based activators. In some examples, an activator (e.g., sodium hydroxide) may be extracted from waste materials such as brine, which may be a by-product of saline. In other examples, an activator for additive manufacturing, additive construction, or a 3D printable geopolymer system for extruding structural construction material can be obtained from waste glass and rice husk ash.

In other examples, one or more additives 140 can be combined with composition 100 or the base mixture. Additives, as an example, may be added to change, modify, add, delete, improve, lessen, greaten, or otherwise affect chemical composition and/or structural properties of material to be extruded in an additive manufacturing, additive construction, or 3D printing system. For example, to make a binder for 3D printing applications, in some examples, a superplasticizer (polycarboxylate ether (PCE), air entrainer, and a viscosity modifier can be combined with a composition or base mixture. In another example, a polymeric additive may be used to enhance the material and/or structural strength of an interlayer bond between printed layers extruded by an additive manufacturing, additive construction, or 3D printing system such as those described herein, without limitation or restriction. In still other examples, accelerators may be added for combination into a mixture (e.g., base, or otherwise).

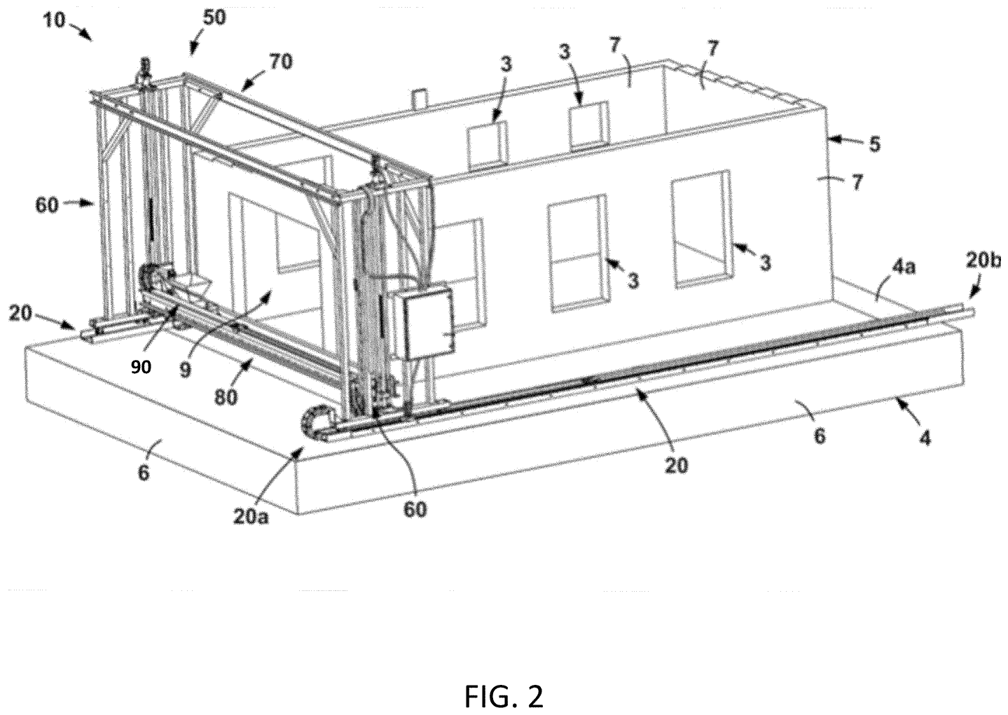

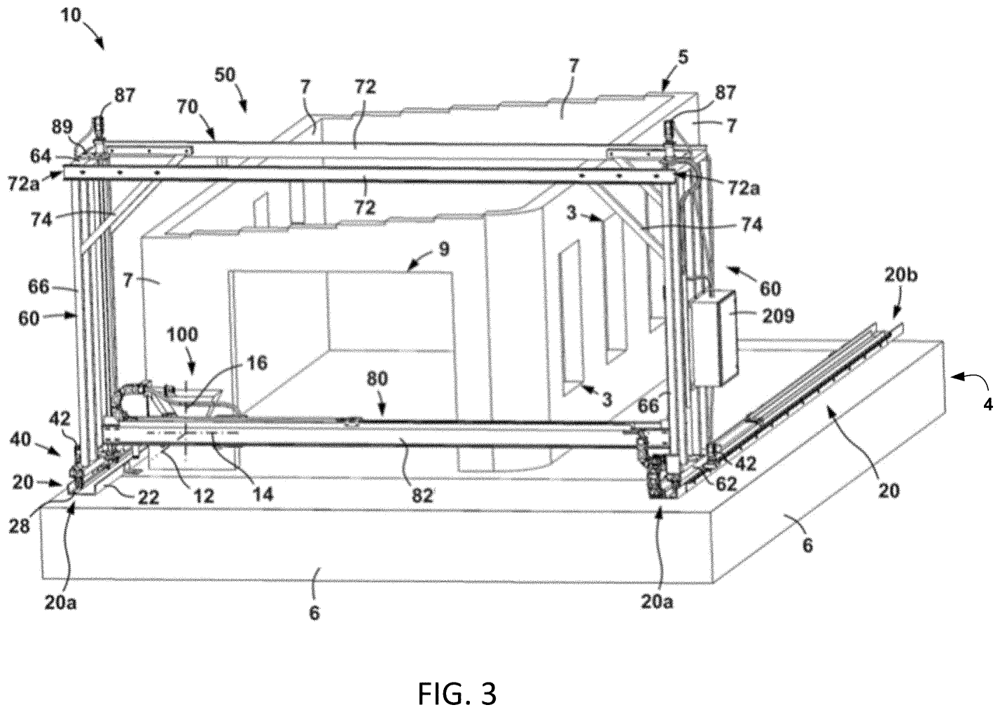

Referring back to FIG. 1A, when activator 120 is a solid (e.g., base (e.g., binder 110 and activator 120) is a solid and sodium silicate is a solid), composition 100 and additives 140 (if present) are mixed with water 145 to yield mixture 150. In some examples, when at least one part of a two-part activator is a liquid (e.g., a base (e.g., binder 110 and activator 120) is a liquid or in solution, sodium silicate is a solution, or both), composition 100 and additives 140, in some examples, may be mixed to yield mixture 150 without the addition of water 145. As an example, an amount of water (which may be varied) may be added to achieve a desired viscosity of mixture 150. When mixture 150 has achieved a desired viscosity, it may be dispensed, distributed, laid, printed, or otherwise extruded (i.e., from a 3D printer, additive manufacturing system, additive construction system, or the like, without restriction or limitation), and then cured using thermal activation (e.g., heat, roasting, or the like, without limitation or restriction) or ultraviolet (UV) radiation resulting in a printed product (e.g., structure 200, which may be a 3D printed concrete structure using extruded or printed material, as described above) such as a geopolymeric structure able to withstand various conditions ranging from radiation to heat or fire to low temperatures. In some examples, a resulting cured composition (e.g., concrete structure 200) may be a geopolymer, with aggregate suspended in the geopolymer to provide various physical characteristics in the cured composition, such as those described above, and others, without limitation or restriction. In other examples, FIG. 1B is an alternative mix formulation for 3D printing of structures. As shown, water may be excluded from combination with a composition created by combining a base mixture (i.e., base 100) including binder 110, activator 120, and aggregate 130. Instead, an “admixture” (i.e., one or more additives such as those described above) may be added without water prior to curing to product the “3D printed product” such as those described, for example, in connection with FIGS. 2 and 3 below. In other examples, the number, type, order, steps, or quantity of elements, compounds, or other materials used to generate the above-described composition(s) may be varied and are not limited to the examples shown and described.

FIG. 2 is a perspective view of an exemplary construction system. Here, construction system 10 includes rail assemblies 20, each of which may be configured to include tread 20a and track 20b. In some examples, construction system 10 includes gantry 50, drive assemblies 60, supports 70, horizontal drive assembly 80, and printing nozzle 90, which is configured to print structure 5 (e.g., with windows 3, walls 7, and door 9) on foundation 4 (having side surface 6). In some examples, printing assembly 90 may be configured to be movably disposed on rail assemblies 20, with drive assemblies 60 and 80 being used to manipulate positioning of printing assembly 90 along vertical and horizontal axes (i.e., to position nozzle assembly 100 in three dimensions along axes 12, 14, and 16).

In some examples, construction system 10 includes rail assemblies 20, each of which may be configured to include tread 20a and track 20b. In some examples, tread 20a may be laid or withdrawn within track 20b using electrical motors and gearing (not shown) that are driven by drive assemblies (not shown) to “pick up” or “lay down” treads 20a. For vertical displacement of printing assembly 90, drive assembly 60 may be implemented to vertically raise or lower printing assembly by using, for example, a screw or worm-type drive mechanism that raises and lowers support 80, which includes horizontal drive assemblies and mechanisms for moving printing assembly 90 in a substantially horizontal direction (in conjunction with vertical movement using drive assembly 60). Gantry 50, moving along rails 20 while printing assembly 100 is raised and lowered can be used to print structure 5 by extruding compositions (such as those described above) to print walls 7 with windows 3 and doors 9 formed by ceasing extrusion while printing based on a pattern that is provided in the form of control signals from control and power unit 209 to printing assembly 90 and drive assembly 60. In some examples, control and power unit may be configured with firmware, software, or circuitry that is used to control gantry 50 to position printing assembly 100 to print structure 5 or, in other examples, different structures beyond the ones that are shown and described.

In some examples, printing assembly 100 may be configured to be movably disposed on rail assemblies 20a-20b, 60 and 66, with drive assemblies 42 and 87 being used to manipulate positioning of one or more nozzles (not shown) in printing assembly 100, which is designed, configured, and positioned in three dimensions along vertical and horizontal axes (i.e., to position printing assembly 100 in three dimensions consistent with axes 12, 14, and 16) to extrude mixture 150 (FIG. 1A) or compositions such as those described above. In some examples, construction system 10 includes printing assembly 100, which may be moved by gantry 50 and positioned in three dimensions along axes 12, 14, and 16 to extrude (i.e., print) mixture 150 or other compositions that can be used to form walls 7, windows 3, door 9, and other structural aspects of structure 5 without the need for structural frames or beams, instead relying entirely on the extruded material that, once cured, provide structural stability and other features such as protection against extreme temperatures (highs and lows, often exceeding hundreds of degrees Celsius), radiation, wind, and other structural forces that are conventionally addressed using structural beams and members such as wood, steel, aluminum, alloys, and the like. Compositions such as those described herein can be printed by construction system 10 to achieve and exceed conventional structural force and environmental parameters.

FIG. 3 is a perspective view of an exemplary construction system. Here, construction system 10 may be configured to print structure 5 on foundation 4. In some examples, construction system 10 includes rail assemblies 20, each of which may be configured to include tread 20a and track 20b on either side of gantry 50 and, along with guidewheel 28, used to move along rails 40. In some examples, construction system 10, each of which have outer rail sides 20 and inner rail sides 22, treads 20a, drive assemblies 40, 42, 62, 80, and 87, gantry 50, vertical side supports 60 and 66, support rails 64, 70, 72a, 74, and 82, support 89, nozzle assembly 100, and control and power unit 209. As shown and described similarly to FIG. 2, tread 20a may be laid or withdrawn within track 20b using electrical motors and gearing (not shown) that are driven by drive assemblies (not shown) to “pick up” or “lay down” treads 20a within track 20b along either side of gantry 50. In some examples, construction system 10 includes rail assemblies 20, each of which may be configured to include tread 20a and track 20b. In some examples, tread 20a may be laid or withdrawn within track 20b using electrical motors (not shown) that are included in drive assemblies (not shown). For vertical displacement of printing assembly 90, drive assembly 60 may be implemented to vertically raise or lower printing assembly by using, for example, a screw or worm-type drive mechanism that raises and lowers support 80, which includes horizontal drive assemblies and mechanisms for moving printing assembly 100 in a substantially horizontal direction (in conjunction with vertical movement using drive assembly 60). Gantry 50, moving along rails 20 while printing assembly 100 is raised and lowered can be used to print structure 5 by extruding compositions (such as those described above) to print walls 7 with windows 3 and doors 9 formed by ceasing extrusion while printing based on a pattern that is provided in the form of control signals from control and power unit 209 to printing assembly 100 and drive assembly 60. In some examples, control and power unit may be configured with firmware, software, or circuitry that is used to control gantry 50 to position printing assembly 100 to print structure 5 or, in other examples, different structures beyond the ones that are shown and described.

In some examples, printing assembly 100 may be configured to be movably disposed on rail assemblies 20a-20b, 60 and 66, with drive assemblies 42 and 87 being used to manipulate positioning of one or more nozzles (not shown) in printing assembly 100, which is designed, configured, and positioned in three dimensions along vertical and horizontal axes (i.e., to position printing assembly 100 in three dimensions consistent with axes 12, 14, and 16) to extrude mixture 150 (FIG. 1A) or compositions such as those described above. In some examples, construction system 10 includes printing assembly 100, which may be moved by gantry 50 and positioned in three dimensions along axes 12, 14, and 16 to extrude (i.e., print) mixture 150 or other compositions that can be used to form walls 7, windows 3, door 9, and other structural aspects of structure 5 without the need for structural frames or beams, instead relying entirely on the extruded material that, once cured, provide structural stability and other features such as protection against extreme temperatures (highs and lows, often exceeding hundreds of degrees Celsius), radiation, wind, and other structural forces that are conventionally addressed using structural beams and members such as wood, steel, aluminum, alloys, and the like. Compositions such as those described herein can be printed by construction system 10 to achieve and exceed conventional structural force and environmental parameters.

Referring to FIGS. 2 and 3, a construction system 10 to perform additive manufacturing, additive construction, and/or three dimensional (“3D”) printing (herein used interchangeably and collectively referred to as “printing” or “3D printing”) of a structure 5, as described above, is shown. In some examples, structure 5 may be a house, dwelling, or any type of building having one or more floors, which may be “printed” using construction system 10. As shown, structure 5 may include walls 7, windows 3 (recesses for which may be printed through the entire width (i.e., thickness) of walls 7), and door frame 9 (which may also be printed to extend through a full width (i.e., thickness) of walls 7). Using the techniques described herein, structure 5 may formed upon foundation 4, being printed using the materials described herein.

As shown, printing assembly 90 movably disposed on gantry 50. As an example, construction system 10 may be configured to form (e.g., print, extrude material to form or shape, or the like) structure 5 using compositions such as those described above in connection with FIG. 1A using, for example, additive manufacturing or additive construction techniques such as 3D printing. In other examples, system 10 using, in some examples, rail assemblies 20 and gantry 50 may be configured to controllably move or actuate printing assembly 90 (FIG. 2) relative to foundation 4 of structure 5 along one or more of orthogonal movement axes 12, 14, 16 such that printing assembly 90 may controllably deposit an extrudable building material, such as the compositions described above, in one or more vertically stacked layers to form structure 5. In some examples, vertically stacked layers of extrudable building material (such as those described above) may be used to form or construct walls 7. In other examples, extrudable building material produced using processes such as those described above in connection with FIG. 1A may be used to form or construct other structural components, elements, or structures and are not limited to those shown and described, which are provided for illustrative purposes only.

As shown in FIG. 3, axes 12, 14, and 16, represented in broken line, are substantially orthogonal to each other, forming a three dimensional set of axes; axis 12 being orthogonal to axes 14 and 16, axis 14 being orthogonal to axes 12 and 16, and axis 16 being orthogonal to axes 12 and 14. Axes 12, 14, and 16 represent the three dimensional (3D) axes of travel for construction system 10 In addition, the origin (not shown) of axes 12, 14, 16 is generally disposed at printing assembly 100 (FIG. 3).

By selectively dispensing the mixture 150 (FIG. 1A) from printing assembly 90 (FIG. 2) as printing assembly 90 moves along axes 12, 14, and 16, construction system 10 can lay down a series of layers to form walls 7 of structure 5.

In some examples, heat curing may help activate a polymeric matrix (i.e., within mixture 150 (FIG. 1A)) to form an interlayer bond strength between, for example, 50 to 100 psi. Additionally, a heated nozzle (not shown) in printing assembly 90 (FIG. 2) or printing assembly 100 (FIG. 3) may have an activation device, mechanism, assembly, or the like, to provide thermal activation or UV curing may be used to assist in final setting of the binder. In some examples, curing temperatures may range from approximately 20° C. to 85° C., but in other examples, curing temperatures may be outside of this range. In other examples, a portion of activator 120 (FIG. 1A) may be dosed at a nozzle (not shown) coupled to printing assembly 90 (FIG. 2) and/or printing assembly 100 (FIG. 3) to help set binder 110 (FIG. 1A).

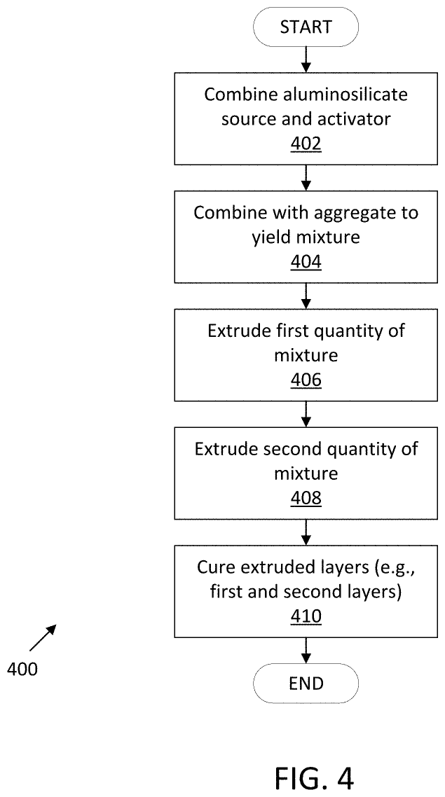

FIG. 4 is an exemplary process for an exemplary mix formulation for 3D printing of structures. Here, process 400 starts by combining an aluminosilicate source (such as those described above) with an activator (again, such as those described above) to yield a mixture (402). Next, the mixture is combined with an aggregate, such as those described above (404). In some examples, the composition including the combination of an aluminosilicate source, an (which may be one or more) activator, and an (which may be one or more) aggregate is mixed and then extruded from a nozzle (not shown), such as that integrated with a 3D printer (e.g., printing assembly 90 (FIG. 2) or 100 (FIG. 3)) (406). Another layer of the composition (i.e., a composition of combined mixture of aluminosilicate, activator, and aggregate) may be extruded from a nozzle (not shown) of printing assembly 90 (FIG. 2) or 100 (FIG. 3) (408). Once layers are extruded to various vertical heights (e.g., in a wythe or other extruded or printed structure (e.g., structure 5)), the layers may be cured using various techniques (410).

For example, curing may be performed using thermal activation by heating extruded layers as mixture passes through a nozzle (not shown). In other examples, curing may be performed when mixture (i.e., a composition of a combined mixture of aluminosilicate, activator, and aggregate) is extruded from a nozzle (not shown) of printing assembly 90 (FIG. 2) or 100 (FIG. 3) and ultraviolet radiation (which may be varied within ultraviolet spectrum wavelength and amplitude) is applied, either during extrusion or after being extruded from a nozzle. Once cured, mixture can cure into various structures, such as those shown and described above. In other examples, process 400 may be varied and is not limited to the examples shown and described.

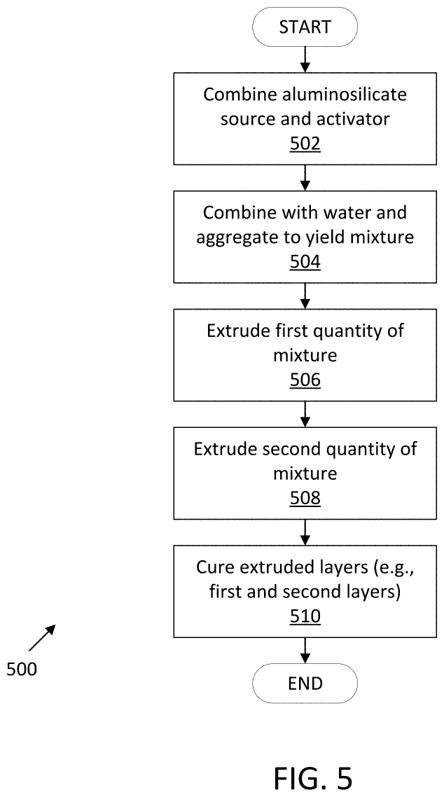

FIG. 5 is an alternative exemplary process for an exemplary mix formulation for 3D printing of structures. Here, process 500 begins by forming a composition using a combination of an aluminosilicate source and an activator (502). As described herein, any combined element or material (natural or synthetic) such as the aluminosilicate source or the activator may include one or more components. For example, multiple activators (i.e., in quantity or type) may be combined as described in 502. Once combined, the aluminosilicate source and the activator may be further mixed with water and aggregate to yield a mixture (504). Next, the combined mixture may be extruded from, for example, a printing assembly such as those described herein (e.g., printing assembly 90 (FIG. 2) or 100 (FIG. 3)) to form a first layer of extruded material (i.e., mixture) (506). A subsequent (e.g., second, third, fourth, and the like, without limitation or restriction) layer may be extruded from the nozzle (not shown) of a printing assembly (508). Once extruded, the layers may be cured using techniques such as those described above, or others, without limitation or restriction (510). In other examples, process 500 may be varied and is not limited to the examples shown and described.

Although the description above has focused on 3D printing of structures, geopolymer compositions such as those described herein can also be used with other additive manufacturing, additive construction, or 3D printing systems. Further, compositions such as those described above may also be used with conventional construction techniques (e.g., pouring into a mold) by displacing the use of other materials (e.g., Portland cement), equipment, and systems, without limitation or restriction.

A number of embodiments of the invention have been described. It will be understood that various modifications may be made without departing from the spirit and scope of the invention. Although the foregoing examples have been described in some detail for purposes of clarity of understanding, the invention is not limited to the details provided. There are many alternative ways of implementing the inventive subject matter. The disclosed examples are illustrative and not restrictive.

What is claimed:

1. A composition, comprising:
an aluminosilicate source; and
an activator.

2. The composition of claim 1, wherein the aluminosilicate source comprises rice husk ash.

3. The composition of claim 1, wherein the aluminosilicate source comprises volcanic ash.

4. The composition of claim 1, wherein the aluminosilicate source comprises crushed rock having alumina.

5. The composition of claim 1, wherein the aluminosilicate source comprises clay.

6. The composition of claim 1, wherein the aluminosilicate source comprises soil having silica.

7. The composition of claim 1, wherein the aluminosilicate source comprises soil having alumina.

8. The composition of claim 1, wherein the aluminosilicate source comprises shale, the shale being comprised in a substantially powder form.

9. The composition of claim 1, wherein the aluminosilicate source comprises ground granulated blast furnace slag.

10. The composition of claim 1, wherein the aluminosilicate source comprises metakaolin.

11. The composition of claim 1, wherein the aluminosilicate source comprises coal fly ash.

12. The composition of claim 1, wherein the aluminosilicate source comprises bottom ash.

13. The composition of claim 1, wherein the aluminosilicate source comprises municipal solid waste incinerator ash.

14. The composition of claim 1, wherein the aluminosilicate source comprises cement kiln dust.

15. The composition of claim 1, wherein the aluminosilicate source comprises limestone dust.

16. The composition of claim 1, wherein the aluminosilicate source comprises silicon dioxide (SiO₂) ranging in mass percentage from substantially 10 mass % to substantially 80 mass %.

17. The composition of claim 1, wherein the aluminosilicate source comprises aluminum dioxide (Al₂O₃) ranging in mass percentage from substantially 2 mass % to substantially 40 mass %.

18. The composition of claim 1, further comprising an aggregate comprising sand.

19. The composition of claim 1, comprising an aggregate, the aggregate further comprising gravel.

20. The composition of claim 1, comprising an aggregate, the aggregate further comprising crushed stone.

21. The composition of claim 1, comprising an aggregate having a size in a range between substantially 1 mm and substantially 2 mm.

22. The composition of claim 1, wherein the activator comprises a base and a sodium silicate.

23. The composition of claim 1, wherein the activator comprises a base, the base further comprising sodium hydroxide.

24. The composition of claim 1, wherein the activator has a mass ratio to sodium silicate of between substantially 1:1 and substantially 2:1.

25. The composition of claim 1, wherein the activator comprises a base, the base further comprising sodium silicate, wherein the base is in solution.

26. The composition of claim 1, wherein the activator comprises a base, the base further comprising sodium silicate, wherein the sodium silicate is in solution.

27. The composition of claim 1, wherein a concentration of a base comprised in the activator is in a range of substantially 4M to substantially 14M.

28. The composition of claim 1, wherein the activator comprises a base and sodium silicate, the base and the sodium silicate being in solid form.

29. The composition of claim 1, further comprising an additive.

30. A method, comprising:
combining a composition comprising an aluminosilicate source and an activator with aggregate to yield a mixture;
extruding a first quantity of the mixture through a nozzle to form a first layer of the mixture;
extruding a second quantity of the mixture through the nozzle to form a second layer of the mixture substantially on the first layer; and
curing the first layer and the second layer to yield.

31. The method of claim 30, further comprising combining water with the mixture before extruding the first quantity of the mixture.

32. A method, comprising:
combining a composition of an aluminosilicate source and an activator, the composition being combined with water and aggregate to yield a mixture;
extruding a first quantity of the mixture through a nozzle to form a first layer of the mixture;
extruding a second quantity of the mixture through the nozzle to form a second layer of the mixture substantially on the first layer; and
curing the first layer and the second layer.

33. The method of claim 32, wherein curing the first layer and the second layer comprises ultraviolet curing.

34. The method of claim 32, wherein curing the first layer and the second layer comprises using thermal activation.

35. The method of claim 32, wherein the curing the first layer and the second layer comprises bonding the second layer to the first layer and the first layer to a substrate.

36. The method of claim 32, wherein curing the first layer and the second layer comprises bonding the second layer to the first layer and the first layer to a substrate, the substrate being a foundation.

37. The method of claim 32, further comprising heating the mixture before extruding the mixture through the nozzle.

38. The method of claim 32, further comprising combining additional activator with the mixture at the nozzle before the mixture is extruded from the nozzle.
